(19) United States
(12) Patent Application Publication
(10) Pub. No.: US 2026/0121341 A1
(43) Pub. Date: Apr. 30, 2026

(54) CONNECTOR

(71) Applicant: YAZAKI CORPORATION, Tokyo (JP)

(72) Inventors: Yusuke Aoki, Kakegawa-shi (JP); Naoto Ikeya, Kakegawa-shi (JP); Takashi Tsukamoto, Kakegawa-shi (JP); Hidetaka Hondo, Sagamihara-shi (JP)

(21) Appl. No.: 19/064,682

(22) Filed: Feb. 26, 2025

(30) Foreign Application Priority Data
Mar. 25, 2024 (JP) 2024-048243

(51) Int. Cl. H01R 13/533; B60L 53/16

(52) U.S. Cl. CPC H01R 13/533; B60L 53/16; H01R 2201/26

(57) ABSTRACT

A connector includes: a terminal to be connected to an electric wire; a housing in which the terminal is housed; and a heat transfer member having a tubular shape in at least a part thereof, and having a tube into which the terminal is inserted. The heat transfer member has an inner tubular surface of the heat transfer member in contact with the terminal, an outer tubular surface in contact with the housing, and a fin structure for heat dissipation at a position not in contact with the housing.

### CROSS-REFERENCE TO RELATED APPLICATION(S)

This application is based upon and claims the benefit of priority from prior Japanese patent application No. 2024-048243 filed on Mar. 25, 2024, the entire contents of which are incorporated herein by reference.

### BACKGROUND

### 1. Field of the Invention

The present disclosure relates to a connector including a terminal to be connected to an electric wire, a housing in which the terminal is housed, and a heat transfer member having a tubular shape in at least a part thereof and having a tube into which the terminal is inserted.

### 2. Description of the Related Art

In the related art, a connector has been proposed for supplying electric power from the outside of a vehicle to charge a battery mounted on a vehicle such as an electric automatic vehicle or a plug-in hybrid automatic vehicle (for example, see JP2017-208247A and JP2020-187920A). This type of connector is generally called a charging inlet.

The above types of connectors (charging inlets) are generally required to have structures and characteristics defined by various standards. For example, when the connector described above is actually used, a temperature of a terminal (so-called operating temperature) rises due to Joule heat generated in the terminal at the time of energization. In view of quality retention, safety, and the like of the connector, an upper limit value and the like of the operating temperature of the terminal are determined by a predetermined standard. In particular, in a case of performing rapid charging of the battery or the like, since a large current passes through the connector in a short time, a degree of temperature rise of the terminal per unit time is higher than that in a case of performing normal charging. Therefore, there is a possibility that it is difficult to keep the operating temperature of the terminal during rapid charging within a range defined by the above standard only by natural heat dissipation. In other words, the limitation of amount of energization currents of the connector from the viewpoint of the operating temperature hinders the shortening of charging time of the battery. On the other hand, simply attaching a heat dissipation member (for example, a metal plate) to the outside of the connector is undesirable because the heat dissipation member may hinder the miniaturization of the connector and because an installation space for the connector inside a vehicle body is limited.

The present disclosure has been made in view of the above circumstances, and an object thereof is to provide a connector capable of preventing an excessive increase in operating temperature of a terminal while avoiding an increase in size of the connector.

### SUMMARY

In order to achieve the above object, a connector according to the present disclosure is characterized by the following.

According to an aspect of the present disclosure, there is provided a connector including: a terminal to be connected to an electric wire; a housing in which the terminal is housed; and a heat transfer member having a tubular shape in at least a part thereof, and having a tube into which the terminal is inserted, in which the heat transfer member has an inner tubular surface of the heat transfer member in contact with the terminal, an outer tubular surface in contact with the housing, and a fin structure for heat dissipation at a position not in contact with the housing.

According to the connector of the present disclosure, when the terminal is inserted into the tube of the heat transfer member, the inner tubular surface of the heat transfer member is in contact with the terminal. Further, the outer tubular surface of the heat transfer member is in contact with the housing and the fin structure of the heat transfer member is disposed at a position not in contact with the housing. Accordingly, the heat generated in the terminal at the time of energization is absorbed and stored by the heat transfer member, so that even when the amount of heat generated in the terminal per unit time is large as in the rapid charging, it is possible to prevent a rapid increase in the operating temperature of the terminal and to gradually increase the operating temperature of the terminal. Further, the increase in temperature of the heat transfer member itself is also prevented by the heat dissipation from the outer tubular surface of the heat transfer member to the housing and the heat dissipation from the fin structure of the heat transfer member to the outside air. Accordingly, the connector according to the present configuration can prevent an excessive increase in the operating temperature of the terminal while avoiding an increase in the size of the connector.

The present disclosure is briefly described above. Further, details of the present disclosure will be clarified by reading modes for carrying out the invention described below with reference to the accompanying drawings.

### BRIEF DESCRIPTION OF THE DRAWINGS

The present disclosure will become more fully understood from the detailed description given hereinbelow and the accompanying drawing which is given by way of illustration only, and thus is not limitative of the present disclosure and wherein:

FIG. 1 is a perspective view illustrating a state in which a connector according to an embodiment of the present disclosure is connected to electric wires;

FIG. 2 is a front view of the connector illustrated in FIG. 1;

FIG. 3 is an exploded perspective view of the connector illustrated in FIG. 1;

FIG. 4 is a perspective view of a heat transfer member illustrated in FIG. 3;

FIG. 5 is a cross-sectional view taken along a line A-A in FIG. 2;

FIG. 6 is a perspective view of a heat transfer member according to a modification; and

FIG. 7 is a cross-sectional view taken along a line B-B in FIG. 6.

### DETAILED DESCRIPTION OF THE INVENTION

### Embodiment

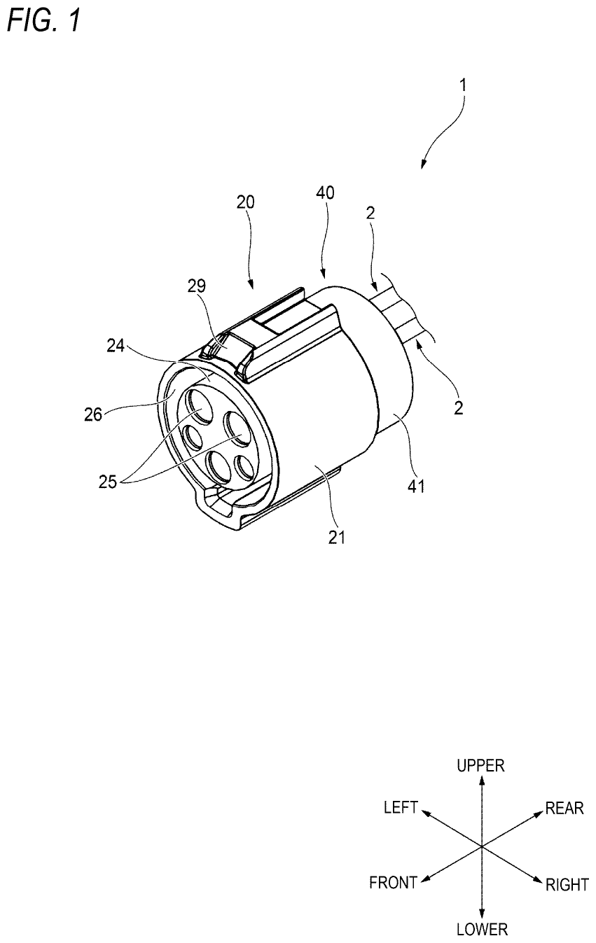

Hereinafter, a connector 1 according to an embodiment of the present disclosure will be described with reference to the drawings. The connector 1 is a connector that is installed in a vehicle such as a plug-in hybrid automatic vehicle or an electric automatic vehicle, and is connected to an electric wire extending from a battery mounted in the vehicle. The connector 1 is also called a charging inlet. By fitting a counterpart connector (so-called charging gun) into a fitting recessed portion 26 (see FIG. 1 and the like) of the connector 1, electric power is supplied to the battery from the outside of the vehicle, and the battery is charged.

Hereinafter, for convenience of description, “front”, “rear”, “left”, “right”, “upper”, and “lower” are defined as shown in FIG. 1 and the like. A “front-rear direction”, a “left-right direction”, and an “upper-lower direction” are orthogonal to one another. The front-rear direction corresponds to a fitting direction of the connector 1 and the counterpart connector (not illustrated), and a front side in the fitting direction (a side closer to the counterpart connector) as viewed from the connector 1 is referred to as a “front side”, and a release side in the fitting direction (a side away from the counterpart connector) as viewed from the connector 1 is referred to as a “rear side”.

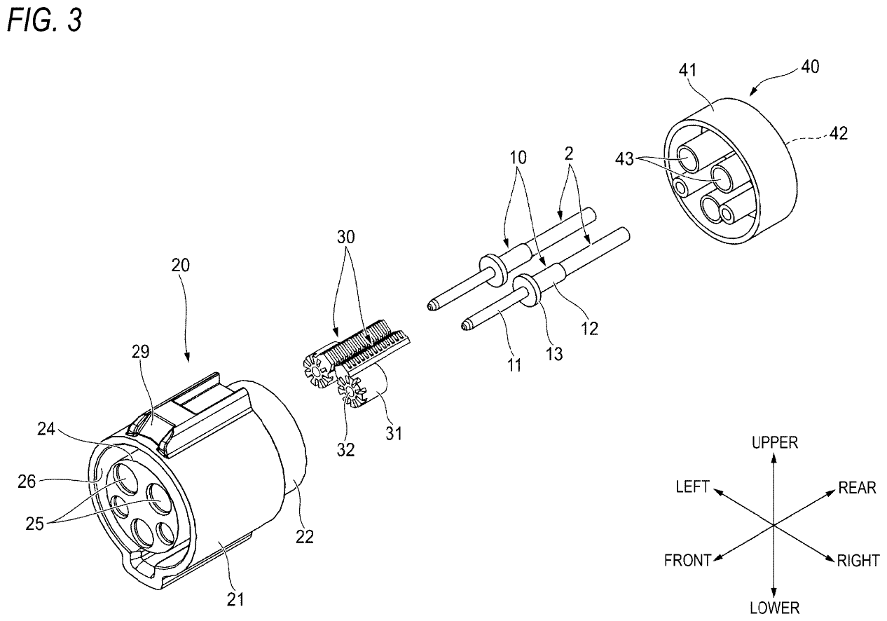

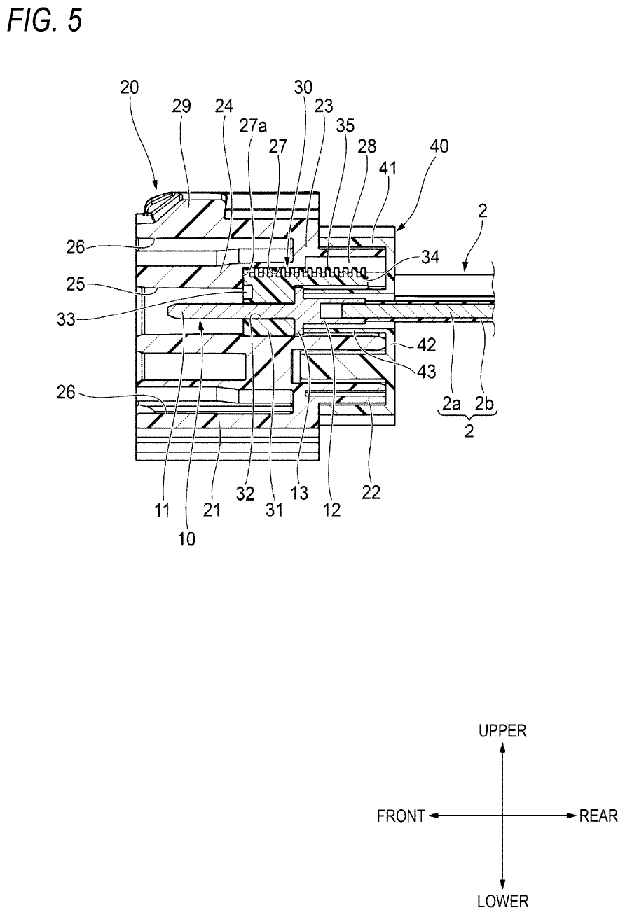

As illustrated in FIGS. 3 and 5, the connector 1 includes a pair of terminals 10, a housing 20 in which the pair of terminals 10 are housed, a heat transfer member 30 accommodated in the housing 20, and a holder 40 attached to the housing 20. One end portions of a pair of electric wires 2 are respectively connected to the pair of terminals 10. The other end portions of the pair of electric wires 2 are connected to a battery (not illustrated). Each of the electric wires 2 includes a conductor core wire 2a and a coating 2b made of an insulating resin and covering the conductor core wire 2a (see FIG. 5). Hereinafter, configuration of each component that forms the connector 1 will be described below in order.

First, the pair of terminals 10 will be described. In the present embodiment, the pair of terminals 10 have the same shape. Each terminal 10 is made of metal and integrally includes, as illustrated in FIGS. 3 and 5, an elongated columnar terminal connection portion 11 extending in the front-rear direction, an elongated cylindrical electric wire connection portion 12 located behind the terminal connection portion 11 and extending in the front-rear direction, and an annular flange portion 13 located at a boundary portion between the terminal connection portion 11 and the electric wire connection portion 12 and protruding in a radial direction. When the connector 1 and the counterpart connector are fitted to each other, the terminal connection portion 11 functions as a male terminal to be connected to a counterpart terminal (a female terminal) belonging to the counterpart connector. The electric wire connection portion 12 is connected to the one end portion of the electric wire 2 by inserting the conductor core wire 2a exposed at the one end portion of the electric wire 2 into a hollow portion of the electric wire connection portion 12 from a rear end opening of the electric wire connection portion 12 and crimping or the like (see FIG. 5).

Next, the housing 20 will be described. The housing 20 is made of resin and integrally includes, as illustrated in FIGS. 3 and 5, a substantially cylindrical housing body 21 extending in the front-rear direction, a substantially cylindrical holder connection portion 22 located behind the housing body 21 and having a smaller diameter than the housing body 21, and a partition wall portion 23 located at a boundary portion between the housing body 21 and the holder connection portion 22 and partitioning a hollow portion of the housing body 21 and a hollow portion of the holder connection portion 22 in the front-rear direction. The holder 40 is attached to the holder connection portion 22 (see FIG. 5). The housing body 21 and the partition wall portion 23 define the fitting recessed portion 26 that is open forward and recessed rearward.

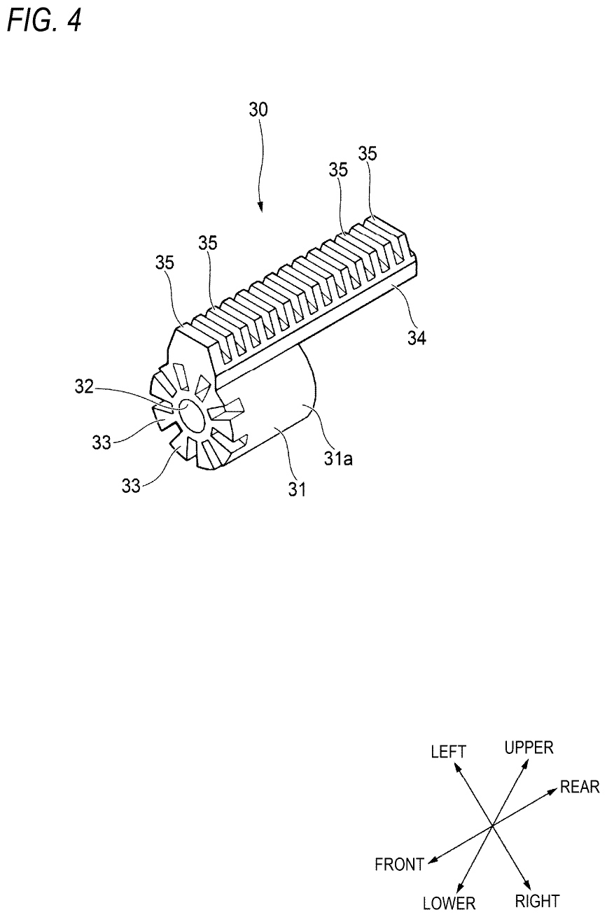

The partition wall portion 23 is provided with a columnar terminal accommodation portion 24 protruding forward (see FIGS. 3 and 5). The terminal accommodation portion 24 is located in the fitting recessed portion 26. A pair of terminal accommodation holes 25 penetrating in the front-rear direction are formed in the partition wall portion 23 and the terminal accommodation portion 24 corresponding to the pair of terminals 10. Front and rear ends of each terminal accommodation hole 25 are open in a front end surface of the terminal accommodation portion 24 and a rear end surface of the partition wall portion 23, respectively. As illustrated in FIG. 5, an accommodation recessed portion 27 for accommodating the heat transfer member 30 (see FIG. 4) is formed in the partition wall portion 23 and the terminal accommodation portion 24 located around the rear end opening of each terminal accommodation hole 25. The accommodation recessed portion 27 is a recessed portion that has a shape corresponding to an outer shape of the heat transfer member 30, is recessed forward, and opens rearward. A bottom surface 27a (see FIG. 5) of the accommodation recessed portion 27 communicates with the terminal accommodation hole 25, and a rear end opening of the accommodation recessed portion 27 communicates with a hollow portion 28 of the holder connection portion 22. A lock portion 29 is provided on an upper end portion of an outer peripheral surface of the housing body 21. When the connector 1 and the counterpart connector are fitted with each other, the lock portion 29 functions to maintain a fitted state of the connector 1 and the counterpart connector (prevent separation of the connector 1 and the counterpart connector) by engaging with a locked portion (not illustrated) belonging to the counterpart connector.

Next, the heat transfer member 30 will be described. The heat transfer member 30 is a member having a function of absorbing heat generated in the terminal 10 at the time of energization and dissipating the absorbed heat to the outside. The heat transfer member 30 is preferably made of a heat transfer material having a better heat transfer property (higher thermal conductivity) than a member (resin) constituting the housing 20, and in this example, the heat transfer member 30 is made of, for example, a highly thermal conductive resin or metal. The material constituting the heat transfer member 30 is also referred to in modifications to be described later.

As illustrated in FIG. 4, the heat transfer member 30 includes a cylindrical tubular portion 31 extending in the front-rear direction. A through hole penetrating the tubular portion 31 in the front-rear direction functions as a terminal insertion hole 32 through which the terminal connection portion 11 of the terminal 10 is inserted. By forming a plurality of recessed portions at equal intervals in a circumferential direction at a corner portion between a front end surface of the tubular portion 31 and an outer peripheral side surface 31a, a plurality of heat dissipation fin portions 33 are formed at a front end portion of the tubular portion 31 so as to extend in the radial direction at equal intervals in the circumferential direction.

A plate-shaped portion 34 extending in the front-rear direction is provided on a part of the outer peripheral side surface 31a of the tubular portion 31 in the circumferential direction so as to continuously extend from a front end position of the tubular portion 31 to a position behind a rear end of the tubular portion 31. A plurality of heat dissipation fin portions 35 are formed on a surface of the plate-shaped portion 34 opposite to the tubular portion 31 so as to be arranged at equal intervals in the front-rear direction over the entire region of the plate-shaped portion 34 in the front-rear direction.

Next, the holder 40 will be described. The holder 40 is a member having a function of holding the terminal 10 and the heat transfer member 30 accommodated in the housing 20 in the housing 20. The rear holder 40 is made of resin and integrally includes, as illustrated in FIGS. 3 and 5, a cylindrical tubular portion 41 extending in the front-rear direction and a rear wall portion 42 closing a rear opening of the tubular portion 41. The tubular portion 41 is attached to the holder connection portion 22 of the housing 20 (see FIG. 5). The rear wall portion 42 is formed with a pair of cylindrical electric wire insertion portions 43 corresponding to the pair of terminal accommodation holes 25 of the housing 20 so as to protrude forward and have a hollow portion penetrating therethrough in the front-rear direction. The pair of electric wires 2 are inserted into the pair of electric wire insertion portions 43 (see FIG. 5). The components constituting the connector 1 have been described above.

Next, an assembling procedure of the connector 1 will be described. First, as preparation for connecting the one end portions of the pair of electric wires 2 to the electric wire connection portions 12 of the pair of terminals 10, the pair of electric wires 2 are inserted into the pair of electric wire insertion portions 43 of the holder 40 from a one end portion side, and then the one end portions of the pair of electric wires 2 located in front of the pair of electric wire insertion portions 43 are connected to the electric wire connection portions 12 of the pair of terminals 10 by means such as crimping. The tubular portions 31 of the pair of heat transfer members 30 are inserted and accommodated in the pair of accommodation recessed portions 27 of the housing 20 (see FIG. 5). The procedure of connecting the electric wire 2 and the terminal 10 and the procedure of accommodating the heat transfer member 30 in the housing 20 may be performed in any order.

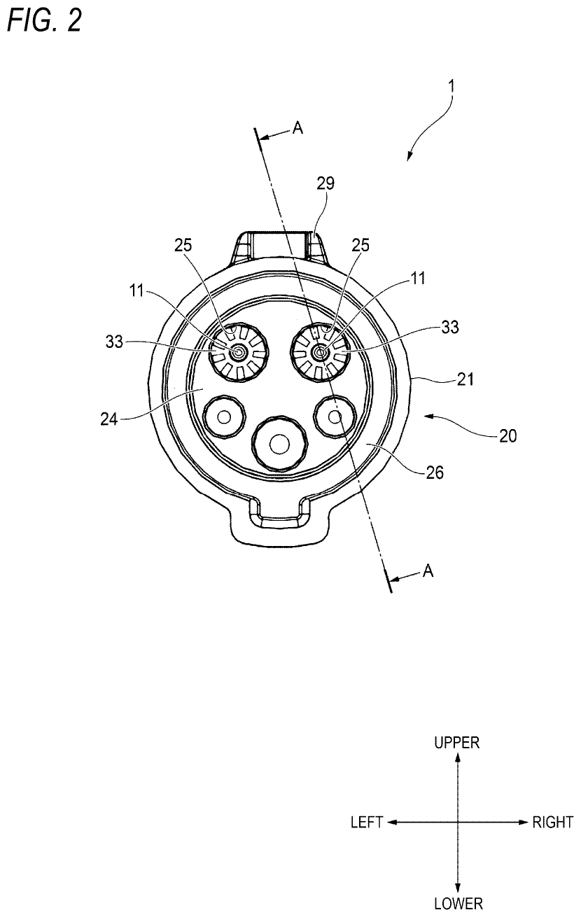

In a state in which the heat transfer member 30 is accommodated in the accommodation recessed portion 27, the outer peripheral side surface 31a (see FIG. 4) of the tubular portion 31 is in contact with an inner peripheral side surface of the accommodation recessed portion 27, and an outer edge portion of the front end surface of the tubular portion 31 is in contact with the bottom surface 27a of the accommodation recessed portion 27. As illustrated in FIG. 2, the heat dissipation fin portion 33 of the heat transfer member 30 is exposed to the terminal accommodation hole 25 of the housing 20. Further, as illustrated in FIG. 5, the heat dissipation fin portion 35 of the heat transfer member 30 (particularly, the heat dissipation fin portion 35 located on a rear side of the tubular portion 31) is exposed to the hollow portion 28 of the holder connection portion 22 of the housing 20. In other words, the heat dissipation fin portion 33 of the heat transfer member 30 and the heat dissipation fin portion 35 of the heat transfer member 30 (in particular, the heat dissipation fin portion 35 located on the rear side of the tubular portion 31) are not in contact with the housing 20.

Next, the pair of terminals 10 are accommodated in the housing 20. Therefore, for each terminal 10, the terminal connection portion 11 is inserted into the terminal insertion hole 32 of the corresponding heat transfer member 30 from the rear side. In a state in which the insertion is completed, the flange portion 13 of the terminal 10 is in contact with a rear end surface of the tubular portion 31 of the heat transfer member 30, and a front side portion (the tip end side portion) of the terminal connection portion 11 is located in the terminal accommodation hole 25 so as to protrude forward from the tubular portion 31. An outer peripheral surface of the terminal connection portion 11 of the terminal 10 is in contact with an inner peripheral surface of the terminal insertion hole 32 of the heat transfer member 30.

Next, the holder 40 is attached to the housing 20. Therefore, the tubular portion 41 of the holder 40 is attached to the holder connection portion 22 so as to cover the outer periphery of the holder connection portion 22 of the housing 20. In a state in which the attachment of the holder 40 is completed, the pair of electric wires 2 extend rearward from the pair of electric wire insertion portions 43 of the holder 40, and the front end surfaces of the pair of electric wire insertion portions 43 of the holder 40 are in contact with the flange portions 13 of the pair of terminals 10 (see FIG. 5). Accordingly, the tubular portion 31 of the heat transfer member 30 and the flange portion 13 of the terminal 10 are sandwiched in the front-rear direction by the bottom surface 27a of the accommodation recessed portion 27 and the front end surface of the electric wire insertion portion 43, so that the terminal 10 and the heat transfer member 30 accommodated in the housing 20 are held in the housing 20.

Therefore, the assembly of the connector 1 is completed, and the connector 1 illustrated in FIG. 1 is obtained. The assembled connector 1 is fixed to an attachment target portion (not illustrated) of the connector 1 provided in the vehicle. When the battery (not illustrated) mounted on a vehicle is charged, the counterpart connector (so-called charging gun) is fitted into the fitting recessed portion 26 of the connector 1 fixed to the attachment target portion of the vehicle. Accordingly, electric power is supplied to the battery from the outside of the vehicle via the counterpart connector, the connector 1, and the pair of electric wires 2 in this order, and the battery is charged.

Next, an operation of providing the heat transfer member 30 in the connector 1 will be described. As described above, when the battery is charged using the connector 1, the temperature of the pair of terminals 10 in the connector 1 rises due to Joule heat caused by energization. In particular, when the battery is rapidly charged, a large current passes through the pair of terminals 10 in a short time, and thus the degree of temperature rise per unit time of the pair of terminals 10 is likely to increase.

In this regard, in the present embodiment, the inner peripheral surface of the terminal insertion hole 32 of the tubular portion 31 of the heat transfer member 30 is in contact with the outer peripheral surface of the terminal connection portion 11 of the terminal 10. Accordingly, the heat generated in the terminal 10 (more specifically, the terminal connection portion 11) at the time of energization is absorbed by the heat transfer member 30 through the terminal insertion hole 32, so that even when the amount of heat generated in the terminal 10 per unit time is large as in the rapid charging, it is possible to prevent a rapid increase in the operating temperature of the terminal 10 and to gradually increase the operating temperature of the terminal 10. Further, the outer peripheral side surface 31a of the tubular portion 31 of the heat transfer member 30 is in contact with the inner peripheral side surface of the accommodation recessed portion 27 of the housing 20, and the heat dissipation fin portions 33, 35 of the heat transfer member 30 are disposed at a position not in contact with the housing 20. Accordingly, the increase in temperature of the heat transfer member 30 itself is also prevented by heat dissipation from the outer peripheral side surface 31a of the heat transfer member 30 to the housing 20 and heat dissipation from the heat dissipation fin portions 33, 35 of the heat transfer member 30 to the outside air.

### Operations and Effects

As described above, according to the connector 1 of the present embodiment, the terminal 10 is inserted into the tube of the tubular heat transfer member 30, an inner tubular surface (the terminal insertion hole 32) of the heat transfer member 30 is in contact with the terminal 10, an outer tubular surface (the outer peripheral side surface 31a) of the heat transfer member 30 is in contact with the housing 20, and a fin structure (the heat dissipation fin portions 33, 35) of the heat transfer member 30 is disposed at a position not in contact with the housing 20. Accordingly, the heat generated in the terminal 10 at the time of energization is absorbed by the heat transfer member 30, so that even when the amount of heat generated in the terminal 10 per unit time is large as in the rapid charging, it is possible to prevent a rapid increase in the operating temperature of the terminal 10 and to gradually increase the operating temperature of the terminal 10. Further, the increase in temperature of the heat transfer member 30 itself is also prevented by the heat dissipation from the outer tubular surface (the outer peripheral side surface 31a) of the heat transfer member 30 to the housing 20 and the heat dissipation from the fin structure (the heat dissipation fin portion 33, 35) of the heat transfer member 30 to the outside air. Accordingly, the connector according to the present embodiment can prevent an excessive increase in the operating temperature of the terminal 10 while avoiding an increase in the size of the connector 1.

The heat dissipation fin portion 33 of the heat transfer member 30 is exposed to a space (the terminal accommodation hole 25) provided in the housing 20 for connecting the terminal 10 and the counterpart terminal, and the heat dissipation fin portion 35 of the heat transfer member 30 is exposed to a space (the hollow portion 28) provided in the housing 20 for accommodating the terminal 10 and the heat transfer member 30 in the housing 20. Accordingly, these spaces generally present in the connector 1 can be utilized for heat dissipation from the heat transfer member 30 to the outside air.

### Other Embodiments

The present disclosure is not limited to the embodiment described above and various modifications can be adopted within the scope of the present disclosure. For example, the present disclosure is not limited to the embodiment described above, and modifications, improvements, and the like can be appropriately made. In addition, materials, shapes, sizes, numbers, arrangement positions, and the like of components in the embodiment described above are freely selected and are not limited as long as the present disclosure can be implemented.

For example, in the above embodiment, the entire heat transfer member 30 is made of a highly thermal conductive resin or metal, which is a heat transfer material having a better heat transfer property (that is, a higher thermal conductivity) than a member (resin) constituting the housing 20. On the other hand, the entire heat transfer member 30 may be made of an elastic material (for example, rubber or highly thermal conductive rubber) that having elasticity higher than that of a member (for example, resin) constituting the housing 20. In this way, when the connector 1 and the counterpart connector are fitted, the terminal 10 can be elastically displaced (so-called core alignment) according to a position of the counterpart terminal, so that it is possible to prevent a contact area between the terminal 10 and the counterpart terminal from being excessively reduced due to a tolerance (so-called manufacturing variation) that may inevitably occur in a manufacturing process of the connector 1. Therefore, an excessive increase in contact resistance between the terminal 10 and the counterpart terminal can be prevented, and heat generated in the terminal 10 at the time of energization can be reduced.

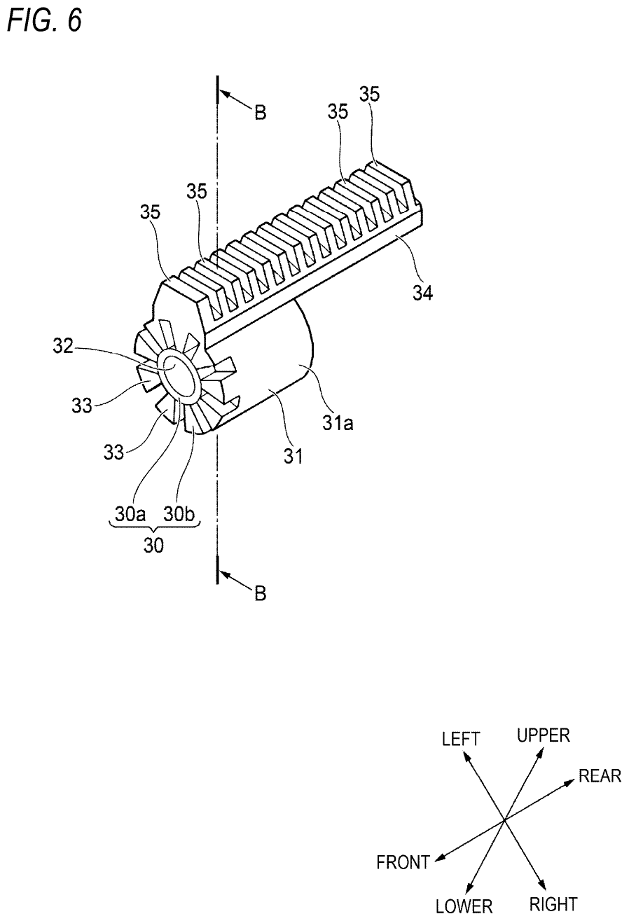

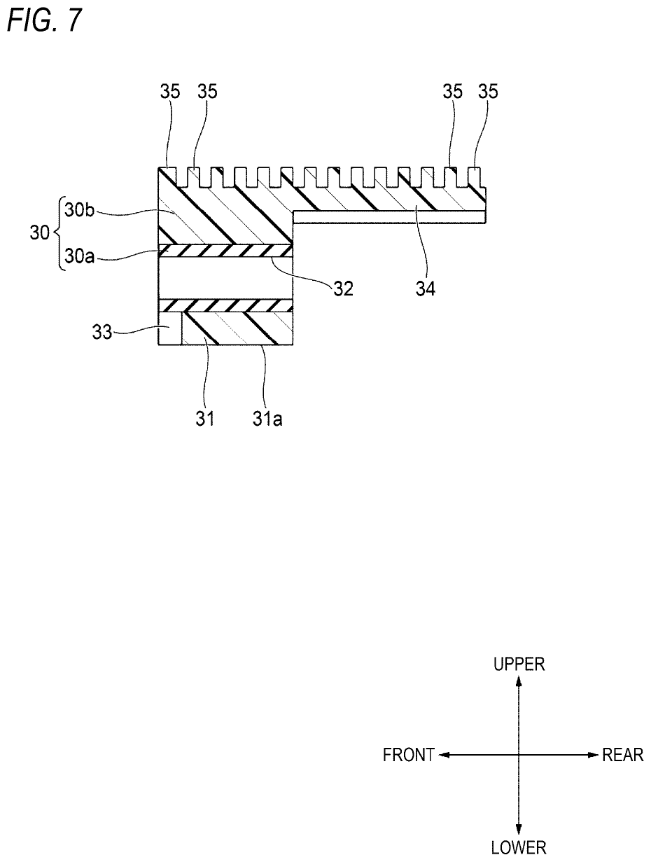

As illustrated in FIGS. 6 and 7, only an inner tubular portion 30a, which is a thin-walled cylindrical portion including the terminal insertion hole 32, of the heat transfer member 30 illustrated in FIG. 4 may be made of the elastic material (for example, rubber or highly thermal conductive rubber), and an outer tubular portion 30b, which is a remaining portion of the heat transfer member 30 illustrated in FIG. 4 excluding the inner tubular portion 30a, may be made of the heat transfer material (for example, highly thermal conductive resin or metal). In the example illustrated in FIGS. 6 and 7, for example, the inner tubular portion 30a and the outer tubular portion 30b may be integrated by insert molding or the like to form the heat transfer member 30, or the inner tubular portion 30a may be accommodated in the outer tubular portion 30b to form the heat transfer member 30. Also in the example illustrated in FIGS. 6 and 7, the same operation and effect as those in the above-described case where the entire heat transfer member 30 is made of the elastic material (for example, rubber or highly thermal conductive rubber) can be achieved.

Here, characteristics of the embodiment of the connector 1 according to the present disclosure described above are briefly summarized and listed in the following [1] to [4].
[1] A connector (1) including:
a terminal (10) to be connected to an electric wire (2);
a housing (20) in which the terminal (10) is housed; and
a heat transfer member (30) having a tubular shape in at least a part thereof, and having a tube into which the terminal (10) is inserted,
wherein the heat transfer member (30) has an inner tubular surface (32) of the heat transfer member (30) in contact with the terminal (10), an outer tubular surface (31a) in contact with the housing (20), and a fin structure (33, 35) for heat dissipation at a position not in contact with the housing (20).

According to the connector having the above configuration [1], when the terminal is inserted into the tube of the heat transfer member, the inner tubular surface of the heat transfer member is in contact with the terminal. Further, the outer tubular surface of the heat transfer member is in contact with the housing and the fin structure of the heat transfer member is disposed at a position not in contact with the housing. Accordingly, the heat generated in the terminal at the time of energization is absorbed and stored by the heat transfer member, so that even when the amount of heat generated in the terminal per unit time is large as in the rapid charging, it is possible to prevent a rapid increase in the operating temperature of the terminal and to gradually increase the operating temperature of the terminal. Further, the increase in temperature of the heat transfer member itself is also prevented by the heat dissipation from the outer tubular surface of the heat transfer member to the housing and the heat dissipation from the fin structure of the heat transfer member to the outside air. Accordingly, the connector according to the present configuration can prevent an excessive increase in the operating temperature of the terminal while avoiding an increase in the size of the connector.
[2] The connector (1) according to [1],
wherein the heat transfer member (30) includes the fin structure (33, 35) exposed to at least one of a space (25) provided in the housing (20) for connecting the terminal (10) and a counterpart terminal and a space (28) provided in the housing (20) for accommodating the terminal (10) and the heat transfer member (30) in the housing (20).

According to the connector having the above configuration [2], the fin structure of the heat transfer member is exposed to at least one of the space provided in the housing for connecting the terminal and the counterpart terminal and the space provided in the housing for accommodating the terminal and the heat transfer member in the housing. Accordingly, these spaces generally present in the connector can be utilized for heat dissipation from the heat transfer member to the outside air.
[3] The connector (1) according to the above [1],
wherein at least a portion of the heat transfer member (30), which is a portion where the heat transfer member (30) is in contact with the terminal (10), is made of an elastic material having elasticity higher than that of the housing (20).
[4] The connector (1) according to [3],
wherein the heat transfer member (30) includes an inner tubular portion (30a) made of the elastic material, and an outer tubular portion (30b) made of a material different from the elastic material and accommodating the inner tubular portion (30a).

According to the connector having the above configurations [3] and [4], in the heat transfer member, at least a portion where the heat transfer member is in contact with the terminal is made of an elastic material having elasticity higher than that of the housing. In this way, since the terminal can be elastically displaced (so-called core alignment) according to the position of the counterpart terminal when the connectors are fitted, it is possible to prevent a contact area between the terminal and the counterpart terminal from being excessively reduced due to a tolerance (so-called manufacturing variation) that may inevitably occur in a manufacturing process of the connector. Therefore, an excessive increase in contact resistance between the terminal and the counterpart terminal can be prevented, and heat generated in the terminal at the time of energization can be reduced.

1. A connector comprising:
a terminal to be connected to an electric wire;
a housing in which the terminal is housed; and
a heat transfer member having a tubular shape in at least a part thereof, and having a tube into which the terminal is inserted,
wherein the heat transfer member has an inner tubular surface of the heat transfer member in contact with the terminal, an outer tubular surface in contact with the housing, and a fin structure for heat dissipation at a position not in contact with the housing.

2. The connector according to claim 1,
wherein the heat transfer member includes the fin structure exposed to at least one of a space provided in the housing for connecting the terminal and a counterpart terminal and a space provided in the housing for accommodating the terminal and the heat transfer member in the housing.

3. The connector according to claim 1,
wherein at least a portion of the heat transfer member, which is a portion where the heat transfer member is in contact with the terminal, is made of an elastic material having elasticity higher than that of the housing.

4. The connector according to claim 3,
wherein the heat transfer member includes an inner tubular portion made of the elastic material, and an outer tubular portion made of a material different from the elastic material and accommodating the inner tubular portion.
